(19) United States
(12) Patent Application Publication
(10) Pub. No.: US 2011/0207094 A1
(43) Pub. Date: Aug. 25, 2011

(54) METHOD FOR TRAINING SPEECH PERCEPTION AND TRAINING DEVICE

(75) Inventors: Martina Bellanova, Erlangen (DE); Maja Serman, Erlangen-Buckenhof (DE)

(73) Assignee: SIEMENS MEDICAL INSTRUMENTS PTE. LTD., Singapore (SG)

(21) Appl. No.: 13/031,799

(22) Filed: Feb. 22, 2011

Related U.S. Application Data
(60) Provisional application No. 61/307,572, filed on Feb. 24, 2010.

(51) Int. Cl. G09B 21/00

(52) U.S. Cl. 434/116

(57) ABSTRACT

The speech perception of hearing-aid wearers and wearers of other hearing devices is intended to be improved. To this end, a method for training the speech perception of a person, who is wearing a hearing device, is provided, in which a first speech component is presented acoustically and the latter is identified by the person wearing the hearing device. Subsequently, there is automated modification of the acoustic presentation of the presented speech component and the aforementioned steps are repeated with the modified presentation until, if the identification is incorrect, a prescribed maximum number of repetitions has been reached. Otherwise, if the first speech component is identified correctly or if the number of incorrect identifications of the first speech component is one more than the maximum repetition number, a second speech component is presented acoustically. This allows a plurality of speech components to be trained in respectively a number of steps.

### CROSS-REFERENCE TO RELATED APPLICATION

This application claims the priority, under 35 U.S.C. §119(e), of provisional application No. 61/307,572, filed Feb. 24, 2010; the prior application is herewith incorporated by reference in its entirety.

### BACKGROUND OF THE INVENTION

### Field of the Invention

The present invention relates to a method for training the speech perception of a person, who is wearing a hearing device, by presenting a speech component acoustically and identifying the acoustically presented speech component by the person wearing the hearing device. Moreover, the present invention relates to a device for automated training of the speech perception of a person, who is wearing a hearing device, with a playback apparatus for presenting a first speech component acoustically and an interface apparatus for entering an identifier for identifying the acoustically presented speech component by the person wearing the hearing device. Here, a hearing device is understood to be any sound-emitting instrument that can be worn in or on the ear, more particularly a hearing aid, a headset, headphones, loudspeakers or the like.

Hearing aids are portable hearing devices used to support the hard of hearing. In order to make concessions for the numerous individual requirements, different types of hearing aids are provided, e.g. behind-the-ear (BTE) hearing aids, hearing aids with an external receiver (receiver in the canal [RIC]) and in-the-ear (ITE) hearing aids, for example concha hearing aids or canal hearing aids (ITE, CIC) as well. The hearing aids listed in an exemplary fashion are worn on the concha or in the auditory canal. Furthermore, bone conduction hearing aids, implantable or vibrotactile hearing aids are also commercially available. In this case, the damaged sense of hearing is stimulated either mechanically or electrically.

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually configured as an electroacoustic transducer, e.g. a miniaturized loudspeaker, or as an electromechanical transducer, e.g. a bone conduction receiver. The amplifier is usually integrated into a signal-processing unit. This basic configuration is illustrated in FIG. 1 using the example of a behind-the-ear hearing aid. One or more microphones 2 for recording the sound from the surroundings are installed in a hearing-aid housing 1 to be worn behind the ear. A signal-processing unit 3, likewise integrated into the hearing-aid housing 1, processes the microphone signals and amplifies them. The output signal of the signal-processing unit 3 is transferred to a loudspeaker or receiver 4, which emits an acoustic signal. If necessary, the sound is transferred to the eardrum of the equipment wearer using a sound tube, which is fixed in the auditory canal with an ear mold. A battery 5, likewise integrated into the hearing-aid housing 1, supplies the hearing aid and, in particular, the signal-processing unit 3 with energy.

Speech perception plays a prominent role in hearing aids. Sound is modified when the sound is transmitted through a hearing aid. In particular, there is, for example, frequency compression, dynamic-range compression (compression of the input-level range to the output-level range), noise reduction or the like. Speech signals are also modified during all of these processes, and this ultimately leads to the speech signals sounding different. Moreover, the speech perception of subjects reduces as a result of their loss of hearing. By way of example, this can be proven by speech audiograms.

De Filippo and Scott, JASA 1978, have disclosed a so-called “connected discourse test”. This test represents the most widely available, non-PC-based speech perception training. The training is based on words. It requires constant attention of and, if need be, intervention by the trainer or tester. The various levels of difficulty depend on intended and random factors, which are the result of the tester, namely the voice type, changes in volume or the like. The test is very exhausting for subject and tester, and is therefore in practice limited to five to ten minutes.

### SUMMARY OF THE INVENTION

It is accordingly an object of the invention to provide a method for training speech perception and a training device which overcome the above-mentioned disadvantages of the prior art methods and devices of this general type, which improves speech perception by targeted training and this training being as automated as possible.

According to the invention, the object is achieved by a method for automated training of the speech perception of a person, who is wearing a hearing device. The method includes:

a) presenting a first speech component acoustically;
b) identifying the acoustically presented speech component by the person wearing the hearing device;
c) automated modification of the acoustic presentation of the presented speech component and repetition of steps a) and b) with the modified presentation until, if the identification is incorrect, a prescribed maximum number of repetitions has been reached; and
d) presenting a second speech component acoustically if the first speech component is identified correctly or if the number of incorrect identifications of the first speech component is one more than the maximum repetition number.

Moreover, according to the invention, provision is made for a device for automated training of the speech perception of a person, who is wearing a hearing device. The device includes:

a) a playback apparatus for presenting a first speech component acoustically;
b) an interface apparatus for entering an identifier (e.g. an acoustic answer or a manual entry) for identifying the acoustically presented speech component by the person wearing the hearing device; and
c) a control apparatus that controls the playback apparatus and the interface apparatus such that there is automated modification of the acoustic presentation of the speech component, and steps a) and b) are repeated with the modified presentation until, if the identification is incorrect, a prescribed maximum number of repetitions has been reached, and a second speech component is presented if the first speech component is identified correctly or if the number of incorrect identifications of the first speech component is one more than the maximum repetition number.

Hence, there is advantageously a change in the presentation if the same speech component is once again reproduced acoustically. This leads to an improved training effect. More particularly, this corresponds to the natural situation where the same words are presented to the listener in very different fashions.

Logatomes or words are expediently used for training speech perception. A logatome is an artificial word composed of phonemes, such as “atta”, “assa” and “ascha”. Each logatome can consist of a plurality of phonemes, with a phoneme representing an abstract class of all sounds that have the same meaning-differentiating function in spoken language.

The logatomes can be used to carry out efficient training with a very low level of complexity. The training can also be automated more easily, with the automated response of the recognition or lack of recognition of a presented test word or test logatome increasing the learning effect.

In one embodiment, a number of speech components are prescribed and steps a) to d) are repeated until all speech components have been presented at least once. This affords the possibility of training a predefined set of logatomes or words in one training session.

More particularly, the speech component can, when repeated, be presented with stronger emphasis compared to the first presentation. In one variant, the speech component can, when repeated, be presented in a different voice or with different background noise compared to the preceding presentation. By way of example, this can prepare hearing-aid wearers for the different natural situations, when their discussion partners articulate spoken words differently or when they are presented with, on the one hand, a male voice and, on the other hand, a female voice.

Furthermore, the speech component can be a logatome at the beginning of the method, and it can be a word into which the logatome has been integrated during its last repetition. If the logatome is in a word, understanding the logatome is made easier because it is perceived in context.

In particular, the speech component reproduced in a modified manner by the hearing device can be identified by the person by using a graphical user interface. The person or the subject then merely needs to select one of a plurality of variants presented in writing, as in a “multiple-choice test”. What is understood may, under certain circumstances, be differentiated more precisely as a result of this.

In a further exemplary embodiment, the presented speech component and the speech component specified by the person are reproduced acoustically and/or optically if the former was identified incorrectly. The acoustic reproduction of both variations immediately provides the person with an acoustic or auditory comparison of the heard and the reproduced speech component. This simplifies learning. This can also be supported by the optical reproduction of both variations.

In a likewise preferred embodiment, the speech component is always presented at a constant volume to the person by the hearing device. This removes one variable, namely the volume, during training. Hence, the person is not influenced during speech perception by the fact that the spoken word is presented at different volumes.

Expediently, all method parameters are set in advance by a trainer and are sent to the person to be trained by the trainer. Hence the training for a person who is hard of hearing can be carried out in a comfortable manner. Furthermore, this means that the training can substantially be without intervention by a tester. The advantage of this in turn is that the tester can evaluate the result without bias and can evaluate it objectively in comparison with other results.

Other features which are considered as characteristic for the invention are set forth in the appended claims.

Although the invention is illustrated and described herein as embodied in a method for training speech perception and a training device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, illustration of a basic design of a hearing aid according to the prior art;

FIG. 2 is a schematic diagram of a training procedure; and

FIG. 3 is a schematic diagram for setting a training procedure according to the invention.

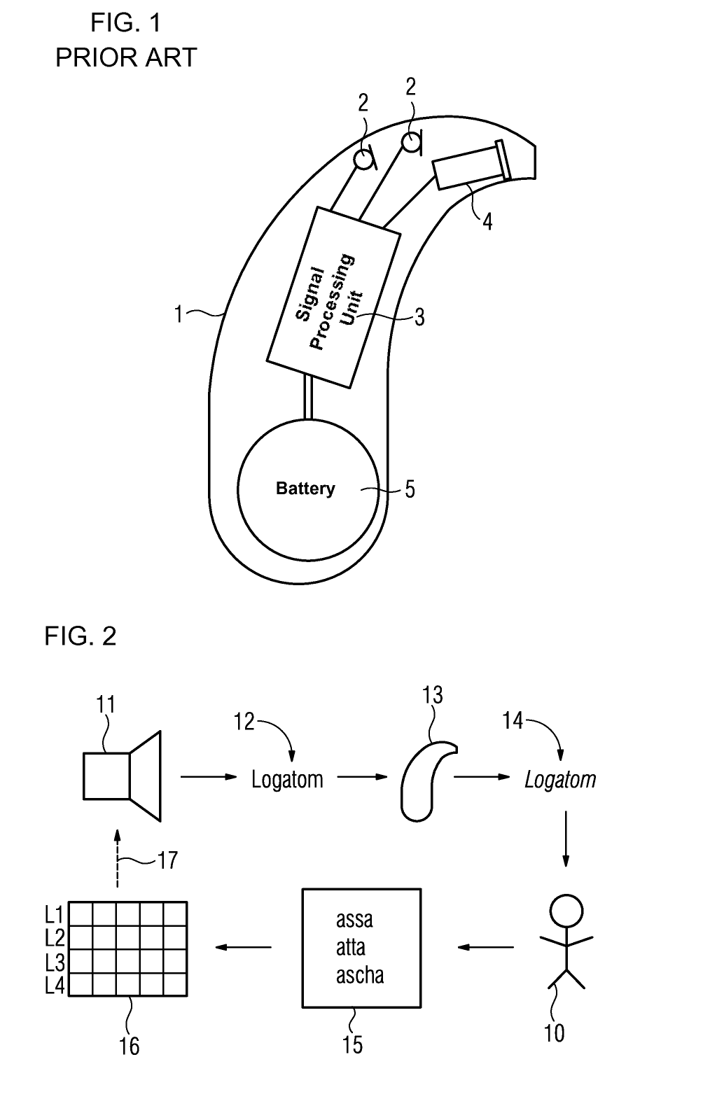

### DETAILED DESCRIPTION OF THE INVENTION

The exemplary embodiments explained in more detail below constitute preferred embodiments of the present invention.

FIG. 2 symbolically reproduces the procedure of a possible variant for training speech perception. A person 10 trains or takes the test. The person is presented with speech components, more particularly logatomes 12, by a speech-output instrument 11 (e.g. a loudspeaker in a room or headphones). By way of example, such a logatome is spoken by a man or a woman with one emphasis or another. The logatome 12 is recorded by the hearing device or a hearing aid 13 worn by the person 10 and amplified specifically for the hearing defect of the person. In the process, there is corresponding frequency compression, dynamic-range compression, noise reduction or the like. The hearing aid 13 acoustically emits a modified logatome 14. The modified logatome 14 reaches the hearing of the person 10 as a modified acoustic presentation.

The hearing-aid wearer, i.e. the person 10, attempts to understand the acoustically modified logatome 14, which was presented in the form of speech. A graphical user interface 15 is available to the person. By way of example, different solutions are presented to the person 10 on the graphical user interface 15. Here, a plurality of logatomes are displayed in writing as alternative answers. The selection of alternative answers can be oriented toward the phonetic similarity or, optionally, other criteria, depending on what is required. The person then selects that logatome displayed in writing that he/she thought to have understood. The result of the selection by the person 10 can be recorded in, for example, a confusion matrix 16. It illustrates the presented logatomes vis-a-vis the identified logatomes. As indicated by dashed arrow 17 in FIG. 2, the test can be repeated without change or with change. In particular, other logatomes or the same logatomes, presented in a different fashion, can be presented during the repetition.

The speech perception training is, as indicated above, preferably implemented on a computer with a graphical user interface. By way of example, it can be developed in a MATLAB environment.

The implemented test method or training method can be implemented in n (preferably four) training stages with acoustic feedback (confirmation or notification of a mistake). In a first training stage, the subject or the person is presented with a logatome or a word as an acoustic-sound example. The person is asked to select an answer from e.g. five optically presented alternatives. If the person provides the correct answer, the acoustic-sound example is repeated and a “correct” notification is displayed as feedback. The person can let the correct answer be repeated, for example if the person only guessed the answer. In the case of a correct answer, the person proceeds to the next acoustic-sound example (still in the first training stage). By contrast, if the person makes a mistake, the person is provided with acoustic feedback with a comparison of the selection and the correct answer (e.g. “You answered ‘assa’ but we played ‘affa’”.) This feedback can also be repeated as often as desired. After the mistake, the person enters the second training stage.

As a result of the mistake, the person has to pass through the second training stage, in which the same acoustic-sound example as in the preceding stage is presented. However, it is presented in a different difficulty mode. By way of example, understanding is made easier by the speech reproduction with clear speech or overemphasis. However, the emphasis can also be reduced for training purposes. After the acoustic-sound example was reproduced, the person must again select an answer from e.g. five alternatives. If the person selects the correct answer, the acoustic-sound example (logatome) is repeated and a “correct” message is displayed or emitted as feedback. The person can repeat the correct answer as often as desired. From here, the person proceeds to the next acoustic-sound example, as in the first training stage. However, if the person makes a mistake, the person, likewise as in the first training stage, is provided with acoustic feedback with a comparison of their selection and the correct answer. This feedback can also be repeated as often as desired. As a result of the mistake, the person must proceed to a third training stage, etc.

In the present embodiment, a total of n training stages are provided. If the person does not understand (n-th erroneous identification) the acoustic-sound example in the n-th training stage ((n−1)-th repetition) either, this is registered in a test protocol. At the end of the training, all acoustic-sound examples that were not understood in any of the n training stages can be tested or trained again in n training stages.

The training procedure (training mode) can be carried out with an increasing, decreasing or constant level of difficulty. Different difficulty modes include, for example, a female voice, a male voice, clear speech by a male voice, clear speech by a female voice, an additional word description, noise reduction, etc.

A fixed training set may be provided, with an adjustable number of acoustic-sound examples and an adjustable number of alternative answers per acoustic-sound example. Moreover, the test or the training can be carried out in quiet surroundings of with different background noises (static or modulated, depending on the purpose of the test).

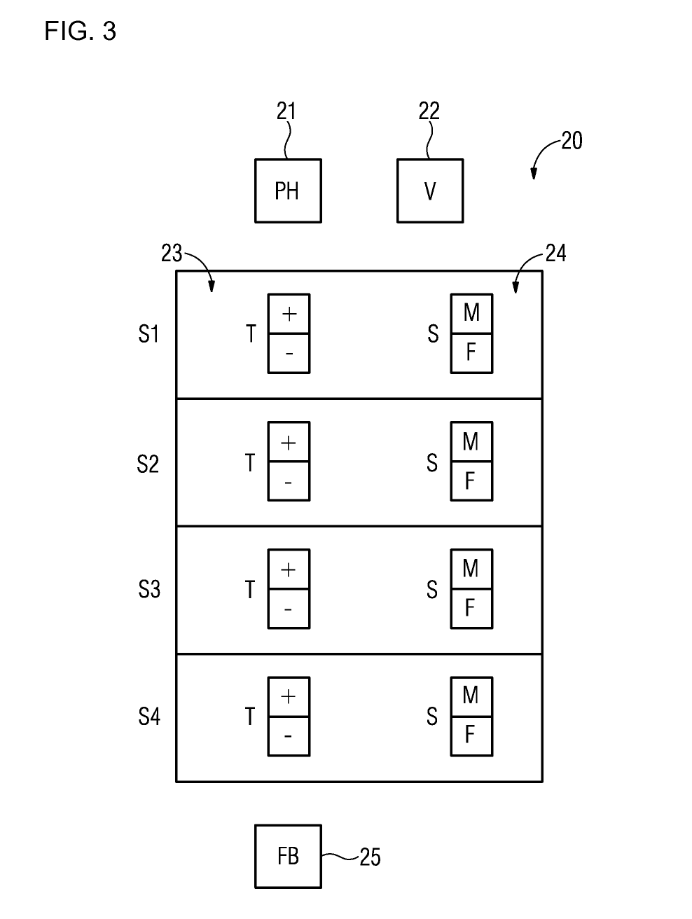

FIG. 3 is used to explain how a training procedure can be set by e.g. an audiologist. The audiologist can set various parameters for the training procedure with the aid of a user interface 20. The audiologist firstly selects e.g. the phoneme type 21. By way of example, this can be a VCV or CVC type (vowel-consonant-vowel or consonant-vowel-consonant), or both. A certain vowel 22 can also be set by the audiologist for the selected phoneme type.

As in the preceding example, the training consists of four stages S1 to S4. The audiologist has the option of setting or tuning 23 the difficulty of the presentation in each stage. Here, for example, background noise may be simulated in different hearing situations. Furthermore, the audiologist can for example set the speech source 24 for each training stage S1 to S4. By way of example, a male or female voice may be selected here. However, if need be, the voices of different men or the voices of different women may also be set. Optionally, the emphasis may be varied as well. In any case, one of the parameters 23, 24 is advantageously modified from one learning stage S1 to S4 to the next. In a concrete example, the degree of difficulty 23 remains the same in all stages, but a female voice is presented as a source 24 in stage S1 for presenting a logatome; in stage S2 it is a male voice for presenting a logatome; in stage S3 it is a clear male voice for presenting a logatome; and in stage S4 it is a word that contains the logatome.

Finally, the audiologist or trainer can configure the feedback 25 for the person undergoing training. To this end, the audiologist for example activates a display, which specifies the remaining logatomes or words still to be trained. Moreover, the audiologist can set whether the feedback 25 should be purely optical or acoustic. Moreover, the audiologist can set whether correct answers are marked in the overall evaluation. Other method parameters can also be set in this manner.

A few technical details with which the test can be equipped are still illustrated below. In a preferred exemplary embodiment, the test is not performed in an adaptive fashion but at a constant volume level. As a result of this, the person can concentrate on learning the processed speech signal, and, in the process, does not need to also adjust to or learn the volume level. This is because speech has acoustic features (spectral changes), which have to be learnt independently of the volume changes (which likewise have to be learnt). The learning effect is increased if the two aspects are separated from one another.

In respect of the training stages, repetition is already a way of learning. The feedback is given automatically after a mistake, and the person can repeat the speech example. In addition to the repetition itself, there are n successive stages of learning, during which a selection can be made as to whether a simple repetition is desired or a modification of the difficulty mode of the stimulus. If the difficulty mode is modified from difficult to easy for the same acoustic-sound example, learning is made easier. It was found that changing the voice of the speaker increases the learning effect. Moreover, the learning effect can also be increased by embedding the acoustic-sound example into context (sentence context). All these effects can be combined to increase or decrease the difficulty of learning.

In a further exemplary embodiment, all test options are determined in advance, independently of the test procedure, and are stored in a settings file. As a result, the test can be conducted within e.g. a clinical study, without the tester knowing the training settings (blind study). Hence, the training settings can already be prepared in advance, and they do not need to be generated during the test, as is the case in most currently available test instruments. Moreover, neither the tester nor the person who is hard of hearing has to worry about the test procedure.

The test or the training can be documented in a results protocol. By way of example, the latter contains the percentage of all understood speech components (logatomes) and the target logatomes (the logatomes that were the most difficult to learn). Moreover, the protocol can also contain a conventional confusion matrix with a comparison of presented and recognized sounds. The results of the test can be an indicator of the extent to which the hearing aid has improved speech perception. Moreover, the result of the test can also be an indicator of the training success. As a result, this may allow a reduction in the number of tests during a training session.

The individual training stages can be carried out with and without additional background noise. As a result, the results can be compared directly (speech perception improvement with background noise compared to speech perception improvement in quiet surroundings). Moreover, this comparison allows a speech perception test of phonemes that are very sensitive to background noise (target noise phonemes).

1. A method for automated training of speech perception of a person, who is wearing a hearing device, which comprises the steps of:
a) presenting a first speech component acoustically;
b) identifying the first speech component acoustically presented via the person wearing the hearing device;
c) automatically modifying an acoustic presentation of the first speech component and repeating steps a) and b) with a modified presentation until, if an identification is incorrect, a prescribed maximum number of repetitions has been reached; and
d) presenting a second speech component acoustically if the first speech component is identified correctly or if a number of incorrect identifications of the first speech component is one more than the prescribed maximum number of repetitions.

2. The method according to claim 1, which further comprises forming the first speech component as a logatome or a word.

3. The method according to claim 1, which further comprises prescribing a number of speech components and repeating steps a) to d) until all the speech components have been presented at least once.

4. The method according to claim 2, wherein a modification in step c) consists of a presentation being brought about with a different voice, different emphasis or different background noise compared to a respectively preceding presentation.

5. The method according to claim 1, wherein the speech component is a logatome at a beginning of the method, and it is a word into which the logatome has been integrated during its last repetition.

6. The method according to claim 1, which further comprises carrying out the identifying step using a graphical user interface.

7. The method according to claim 1, wherein a presented speech component and the speech component specified by the person are reproduced at least one of acoustically or optically if the former was identified incorrectly.

8. The method according to claim 1, wherein the first speech component is always presented at a constant volume to the person by the hearing device.

9. The method according to claim 1, which further comprises setting all method parameters in advance by a trainer and are sent to the person to be trained by the trainer.

10. A device for automated training of speech perception of a person, who is wearing a hearing device, the device comprising:
a playback apparatus for presenting a first speech component acoustically; and
an interface apparatus for entering an identifier for identifying the first speech component acoustically presented by the person wearing the hearing device; and
a control apparatus for controlling said playback apparatus and said interface apparatus such that there is automated modification of the acoustic presentation of the first speech component, and the presenting of the first speech component and the entering of the identifier for identifying the first speech component are repeated with a modified presentation until, if an identification is incorrect, a prescribed maximum number of repetitions has been reached, and a second speech component is presented if the first speech component is identified correctly or if the number of incorrect identifications of the first speech component is one more than the prescribed maximum number of repetitions.
